(19) United States
(12) Patent Application Publication
(10) Pub. No.: US 2004/0249892 A1
(43) Pub. Date: Dec. 9, 2004

(54) Secure header information for multi-content e-mail

(76) Inventors: Luis Barriga, Skarpnack (SE); Jan-Erik Mangs, Solna (SE)

Correspondence Address: ERICSSON INC., 6300 LEGACY DRIVE, M/S EVR C11, PLANO, TX, 75024, US

(21) Appl. No.: 10/480,602

(22) PCT Filed: Jun. 18, 2002
(86) PCT No.: PCT/SE02/01220

(30) Foreign Application Priority Data
Jul. 4, 2001 (SE) 0102437-1

(51) Int. Cl. G06F 15/16; G06F 12/14; G06F 11/30; H04L 9/32

(52) U.S. Cl. 709/206; 713/201

(57) ABSTRACT

A multicontent e-mail has a body part comprising separately encrypted content parts and a header part comprising a clear text part and an encrypted part. The encrypted header part includes a descriptor section and a link section. The link section specifics relationships between content parts. The descriptor section provides information related to each body content part such as information format. The descriptor section, further, provides information for access to any content part such as requirement for authorization. The access information can include executable code exemplary for establishing a negotiation process for access to linked information at a remote information server. Further disclosed is an arrangement for download and decryption of the e-mail header part and analysis of the descriptor section. A user can select any body content part for downloading according to requirements determined from the descriptor section.

### BACKGROUND OF THE INVENTION

1. Technical Field of the Invention

The invention generally relates to e-mail communications and, more particularly, to methods for improved security in the transmission of multi-content e-mail, and devices therefor.

2. Background of Invention

E-mail is a well-known and widely used form of asynchronous communication. It has also become common to attach documents to e-mail or links to information stored at remote locations. A further technical development has allowed the creation of complex multi-content e-mail, also known as e-mail with attachments, comprising a plurality of linked mail body parts of various types. As e-mail has become an essential part of the infrastructure of many businesses, the security aspect has become a primary question. It is common to transmit e-mail over an Internet. However, standard Internet e-mail is not secure. Therefore, encryption and/or digital signatures are often used to protect e-mail contents against undesired disclosure or to preserve integrity. Indeed, on the Internet, when end-to-end security is a strong requirement, secure e-mail is today the only acceptable solution when handling confidential e-mail, such as corporate or private e-mail.

It has also become common to access mailboxes through a mobile device, e.g. a mobile phone or a Personal Digital Assistant (PDA), communicating with a network over a radio interface. Although such devices are increasingly becoming more capable, there are still constraints limiting what information can be processed and presented to a user. It is also important to efficiently utilize a wireless link and still be able to capture essential e-mail information. It may, therefore, be advantageous if a client has information about the structure of a received multi-content e-mail and further is able to select parts of a complex multi-content e-mail for transfer over a wireless link with limited capability. It may, further, be advantageous to perform complex operations on e-mail requiring information about its structure and contents. In order to perform such operations in traditional e-mail systems, a server must have full access to the e-mail body. Thus, in this case, there must be a trust relationship between client and server, which is not the case if the server is located in the public domain of the Internet. On the contrary, if an e-mail has been encrypted, a server has no means to determine its structure because the e-mail is encrypted as a whole and the above mentioned operations can not be performed. A client has to download the whole e-mail and decrypt it in order to have information about its structure.

There is, thus, a problem related to the processing of complex multi-content e-mail accessed at a mail server in the public domain over a wireless link of limited capability.

Another problem is related to the use of mobile devices, communicating over a wireless link, and having limited capabilities to process complex multimedia e-mail. It would be advantageous if a user could select which parts of a complex e-mail to download in order not to unnecessarily overload a mobile device resulting in excessive processing time.

Still another problem is related to the fact that e-mail may be limited with respect to volumes of data carried. A complex multi-content e-mail may include large multi-media files easily exceeding any limitations to the e-mail size. It would be advantageous to allow attachment of large files to an e-mail such as to overcome limitations to the maximum e-mail size and still allow a user secure access to the attached information.

There is, thus, a need for a method and arrangement eliminating the above mentioned deficiencies of known e-mail systems.

3. Description of Related Art

Several methods are known for securing e-mail on the Internet, e.g. based on the standard S/MIME. A de facto standard Pretty Good Privacy (PGP) is also common in the art. However, these methods only allow secure e-mail for point-to-point communication, i.e. when both parties have a certificate or public key pair. For domain-to-point mail, e.g., mail from a company (corporate domain) to a receiver in a public domain, gateway-based solutions have been proposed. Exemplary, Applicants' Assignee's co-pending U.S. patent application Ser. No. 09/198,822, entitled “Method and System for Security Data Objects”, filed on Feb. 24, 1998, discloses a method whereby plain text e-mail from within a domain is automatically secured by a gateway before leaving a domain. An IETF proposed protocol describe a secure e-mail method for domain-to-domain security, also based on gateways. In domain-to-point or domain-to-domain secure e-mail, gateways at the edge of each domain perform partial or full e-mail protection. With partial protection, gateways protect or secure (e.g., by encryption) parts of an e-mail message, usually the body, but leave the headers in plain text. With full protection, the whole e-mail, body plus header, is protected (e.g., encrypted). A minimal header part comprises information needed for delivery of the message (commonly the receiver's address) and is left unprotected. The reason behind protecting at least part of the header is that headers can reveal potential confidential information and can also make possible tracking of a user's communication behavior. The entire header is provided as a body part in the protected body portion of a full-protection e-mail.

On the client side, when using full-protection e-mail, a standard e-mail client, in order to access the entire header for analysis must request download of the entire e-mail. This is inconvenient if the client is a mobile client connected over an air interface. Applicants' Assignee's co-pending U.S. patent application Ser. No. 09/671,758, entitled “Agent-based secure handling of e-mail header information”, filed on Sep. 26, 2000 discloses a method for full-protection of e-mail further allowing a client to analyze header information prior to download of the body part. However, this method is limited to e-mail with a single body part and is not applicable to multi-content e-mail.

Multi-content mail may also contain complex structures e.g. link structures linking different parts of the mail body. H. Thimm et al. (“A Mail-Based Tele-service Architecture for Archiving and Retrieving Dynamically Composed Multimedia Documents”, XP 000585292) describes an arrangement for archiving and retrieving multimedia documents. A specific link part of the mail body describes the relationships between different content parts of the mail. A client uses a dedicated protocol for accessing parts of the multi-content mail or building an instance of the e-mail according to client preferences. The arrangement of H. Thimm et al. Further includes storing of information at a specified network node and including, in the e-mail, a reference for retrieving the information. The need for such an arrangement derives from the fact that there may be limitations to the size of a file being attached to e-mail.

An arrangement that is disclosed by R. Ludwig (German patent 197 18 654, “Kommunikationssystem fur Elektronische Nachrichten”) uses an Assignment Data Block to describe the structure of a complex multi-content e-mail. These documents, however, do not address the problem of secure e-mail nor the problem of secure access to information stored at a network node and only included in the e-mail by reference. C. Gehrmann describes in Swedish patent application 0002962-9, entitled “Securing Arbitrary Communication Services”, how to secure an arbitrary communication service e.g. for access to stored files.

According to Gehrmann a user requesting access to secure information, e.g. encrypted information, first downloads a proxy comprising executable code. In a first step of the method the service provider and the user client are authenticated. The proxy may include conditions for access such as requirement for payment and, further, includes a method for secure exchange of keys and for encryption/decryption of data. Successful execution of the proxy code results in a secure communication between the service provider and the client. The proxy code preferably use a common computing platform and language such as the Java™ virtual machine and the Java™ byte code computing language. Particulars of the method for securing information at the server may thus be included in the executable code. A flexible access is, therefore, provided by the method to secure information stored at a network server.

The use of descriptor files to describe the contents of an object file is also known from other areas than e-mail communication. For example, a document generated by Microsoft Office tools has a properties file describing various properties of the object file. Image standards, e.g. MPEG7 and JPEG2000, allow for the inclusion of descriptive information. Some of this information may be generated by the system, e.g. size of object file, whereas the user may specify other information. It has become common to use The Extensible Markup Language (XML), specified by the World Wide Web Consortium (http://www.w3.org/) to obtain a universal format of the description.

A multimedia file, attached to an e-mail, may be generated locally by a user. However, it will also be common to obtain multimedia information from a service provider by connecting to a service node. The service provider may then allow free access to limited information only whereas access to the full information will be allowed on condition e.g. that payment has been made. The international application WO 00/31964 discloses a method and device for partial encryption and progressive transmission of images. Images are coded, e.g. according to the JPEG format, such as to form a stream of coding units, which can be independently encrypted. The image header includes an encryption header specifying how each coding unit is encrypted.

This information may include session keywords and encryption algorithm identifiers. Data relating to security may be protected e.g. using a public key algorithm such as Diffie Hellmann, or RSA (Ravest-Shamir-Adleman).

Although the above references address in general the problem of describing properties of an object file and secure access to a file over a data network, they do not disclose compiling a multi-content secure e-mail from several sources such as to allow independent secure access to individual e-mail body parts.

### SUMMARY OF INVENTION

It is an object of the present invention to provide a method and system for secure access of multi-content structured e-mail. Another object of the invention is to provide a method and system for user controlled download of secure e-mail body parts.

A further objective of the invention is to provide a method and system for analysis of secure e-mail header information for determining download control actions at least partly in consideration of wireless channel characteristics, client terminal capacity, and user requirements.

A still further objective of the invention is to provide a method for secure e-mail including convenient secure access to information that resides at a specified network node.

According to a preferred embodiment of the present invention, a secure multi-content e-mail comprises at least an encrypted body part and an, at least partly, encrypted header part. The at least encrypted body part may represent a complete media file, part thereof or a link to information stored at a network node. The at least partly encrypted header part has a first clear text header part comprising information minimal for routing the e-mail, and a second encrypted part at least comprising the complete header information, a body structure description part and information for access to the body parts. A client, e.g. a mobile terminal, may request download of the header information and, separately therefrom, download of specified body parts. By decrypting said encrypted header structure part and analysis of the same, a client may determine body parts for subsequent download. Body parts, residing in clear text at a location other than the e-mail server, may be referenced as described e.g. by H. Thimm et al. However, in case that the remote information is protected a procedure is required including authentication and encryption. The present invention discloses a method for convenient access to such information having been included by reference in a secure e-mail.

These objectives are obtained by a system and method as set out in the appended claims. Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

A more complete understanding of the system and method of the present invention may be obtained by reference to the following Detailed Description when taken in conjunction with the accompanying drawings wherein:

FIG. 1 shows an exemplary arrangement at the sending side.

FIG. 2 is a flowchart illustrating the steps in the creation of a multi-content e-mail.

FIG. 3 illustrates an exemplary arrangement at the receiving side.

FIG. 4 is a flow chart illustrating the steps when accessing a received multi-content e-mail.

### DETAILED DESCRIPTION OF THE PREFERRED EMBODIMENT

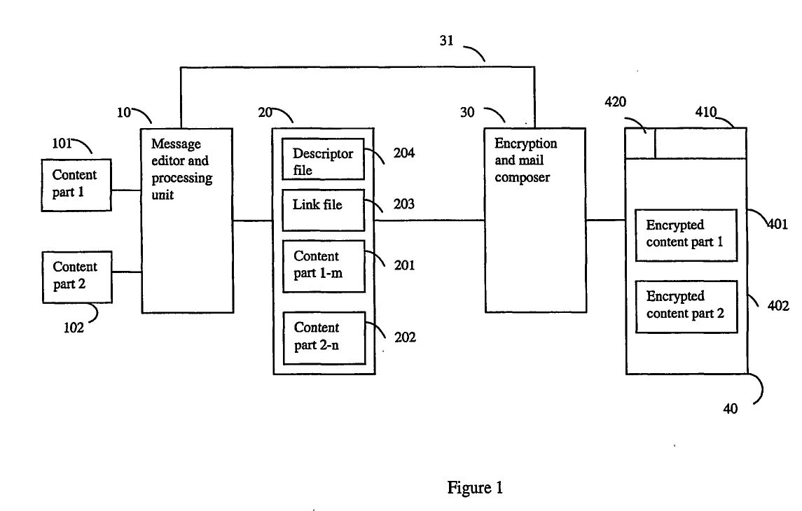

The present invention will now be described more fully hereinafter with reference to the accompanying drawings in which a preferred embodiment of the invention is shown. Referring to FIG. 1, an input-processing unit is shown at 10. The unit 10 compiles a message comprising a plurality of message parts of which two are illustrated at 101 and 102. An input file, e.g. input file 101, may be generated in a plurality of ways, e.g. by a word processor, by a photographic device or retrieved from a storage unit. The unit 10 has the capacity to identify the type of input file and to adapt its processing correspondingly.

The user may create hypermedia e-mail by defining links between body parts. A link may also refer to an external location from which the corresponding body part is retrieved at link activation. The unit 10 may include functions for recognition of the type of input file e.g. input files 101 and 102, and for extraction of any associated properties files such as properties related to a word processing file or to an image file, e.g. a JPEG file. The output from unit 10 is shown at 20. Links between body parts are compiled at 203 in a link file. The editing and processing of content parts 101 and 102 results in body parts 1-m and 2-n where m and n indicates that the original body parts may now exist in several versions, e.g. representing different image information parts. The image information parts can, e.g., represent higher order bit planes or specific image parts such as Region Of Interest as defined in the JPEG2000 standard (“JPEG2000 Part I Final Draft International Standard”, ISO/IEC FDIS15444-1). Further, the output from unit 10 includes a descriptor file 204 comprising data pertinent to the various content parts, e.g. content parts 201 and 202. The descriptor file data may include access information for locating and retrieving a body part, and data relating to the size of a content part, type of content part, and coding method. A client may use this information to request download of selected parts for example an image and may recreate an image in several steps related to content and resolution. An input file, exemplary content part 1 at 101 in FIG. 1, may be provided for download at an information server. In this case the information provider may allow free access to a limited information only whereas full access requires fulfillment of certain conditions. In preparing a multi-content e-mail, a user may retrieve the free information and, in addition, executable access code for conditional access to the full information. The access code may be included in the descriptor file at 204 in FIG. 1 or referenced therefrom to a storage location in the body part of the e-mail. Part of the free information may comprise a description of the full information. Whenever the e-mail receiver attempts to access other than free information, the access code is executed and download of the requested information part may take place at fulfillment of specified conditions. A common first step in retrieving information from a service provider is to authenticate the provider. By including the access code in the e-mail, the authentication has already been made and need not be performed by the receiver of the e-mail. If the access code were otherwise downloaded at the time for the receiver activating a link to a remote server, authentication of each such remote server would consume unnecessary computational power. According to the preferred embodiment, the receiving client would advantageously only need to authenticate the sender of the e-mail.

An input file, exemplary content part 2 at 102 in FIG. 1, may further relate to information owned by the sender of the e-mail but which is preferred to be stored at a service node. The reason may be a large size of the information and/or that the sender expects to reuse the information in other communications. In this case, the sender of the e-mail stores the encrypted content parts at a remote server and prepares access code and descriptive information to be included in the e-mail as discussed above. In the case that a body part includes the complete information, i.e. it is not a link to a remote location, then the access code reduces to an internal address within the e-mail. The access code may, further, include keyword and encryption algorithm allowing a user to decrypt the body part. In the case that the sender of the e-mail has stored a link in the e-mail to a remote storage location, the access code comprises address information to the stored information and may, further, include keyword and encryption algorithm. Finally, if at least part of the e-mail body part is retrieved from a service provider the access code comprises executable code. The executable code causes the client to connect to the service node and exchange keys and other information, e.g. credit card information, for establishing the conditions for secure download of the requested information.

At 30 there is shown an encryption and mail composer unit. The unit 30 separately encrypts the various body parts, e.g. body parts 1-m and 2-n, and inserts the encrypted parts in the body part of output e-mail 40 as illustrated at 401 and 402. The unit 30, further, encrypts the descriptor file 204 and inserts the encrypted result descriptor file into the e-mail header as an extended field 410. The encryption and mail composer 30 in this embodiment of the present invention utilizes a feature of Internet Standard RFC822, according to which standard the protected e-mail can, in some instances, be produced. In particular, the RFC822 standard permits the header of an e-mail to contain additional extended header fields of arbitrary length. The link file 203, amended to reflect the correct locations of the encrypted body parts, may be included in the extended field 410 or as a separate body part of e-mail 40. Further, the unit 30 receives at 31 from the input-processing unit 10 information pertaining to the routing of the e-mail lo to the intended receiver. This information is entered as clear text into the e-mail as a minimal header 420. The header part 420 is minimal comprising limited information needed for the routing and, thus, does not permit analysis of e-mail contents or traffic or network analysis of e-mail communications. This type of information is provided only in the encrypted parts of the mail.

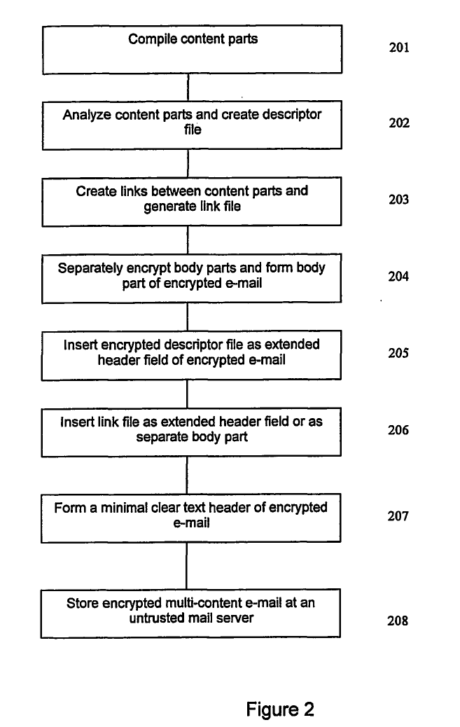

FIG. 2 is a flow chart illustrating the steps involved in the creation of a multi-content secure e-mail according to the invention. At step 201 a user compiles the various content parts, content descriptive information, and access information for access to content parts e.g. located at remote servers. At 202 an analysis is made of the content parts and an e-mail descriptor file is generated comprising descriptions of the content parts including those stored remotely. This step further includes handling of the access code for insertion into the e-mail descriptor file or a separate body part.

Step 203 involves creation of links between content parts and generation of a link file. At step 204 each content part is separately encrypted and inserted into the body part of a result secure e-mail. At step 205 the descriptor file is encrypted and inserted into the result e-mail header as an extended field. At step 206 the link file is added to the result e-mail either as part of an extended header field or as a separate body part. A minimal e-mail header is created at step 207. The minimal header allows for routing but no other information is contained therein. The result secure multi-content e-mail is stored at an untrusted mail server in step 208.

Preferably, a mobile client is able to analyze contents and structure of e-mail and to request download of those parts only that can be efficiently transferred over the air interface and that can be processed by the mobile client considering limitations to its processing capacity.

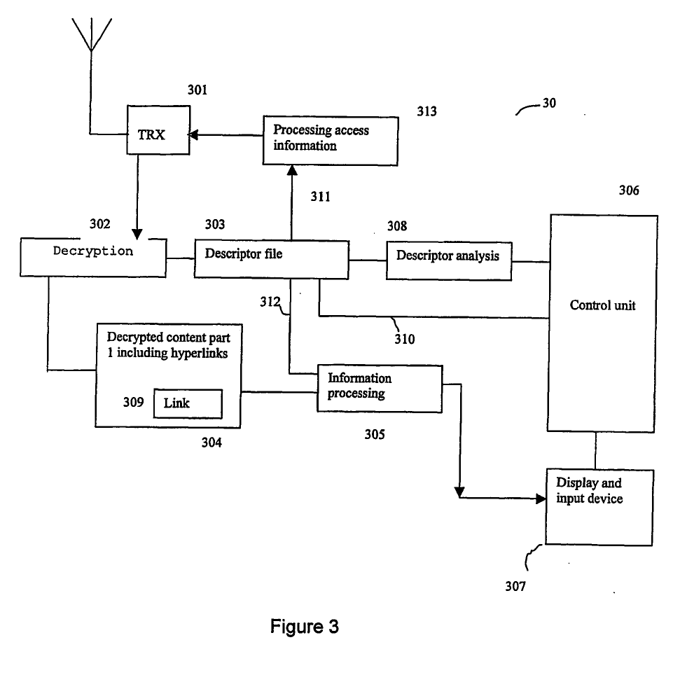

FIG. 3 is an exemplary arrangement at the receiving client side. The arrangement 30 may be implemented in a mobile device communicating over a wireless link with a network. According to FIG. 3 there is a radio transceiver at 301. A control unit 306 controls the internal processing of arrangement 30. At 302 there is shown decryption means. The downloaded e-mail header extended part, including the descriptor file, is decrypted by means 302 and stored at storage means 303 further including the link information. Means 308 performs an analysis of the descriptor file and generates, through control unit 306, a user interface displayed at display and input means 307. Storage means 304 contains at least a first decrypted content part, which may further contain link information as illustrated at 309. Storage means 304 may cache several content parts or serve as a buffer means during the presentation at display 307 of the information. Prior to displaying the information at unit 307, the information processing unit 305 processes the information, e.g. decompressing a JPEG image. The unit 305 may use type information provided in the descriptor file a unit 303. This and other information for the processing of unit 305 is retrieved from unit 303 through the internal link 312. In dependence of user input at display and input device 307, the control unit may request at 310 means 303 to generate a new user interface related to a selected content part or to request, at 311 download of the content part. The download request is first processed at 313 with regard to access conditions and may result in the execution of an access code for communication with a remote server. The output of unit 313 results in load requests directed to the e-mail server or a remote server through the transceiver 301.

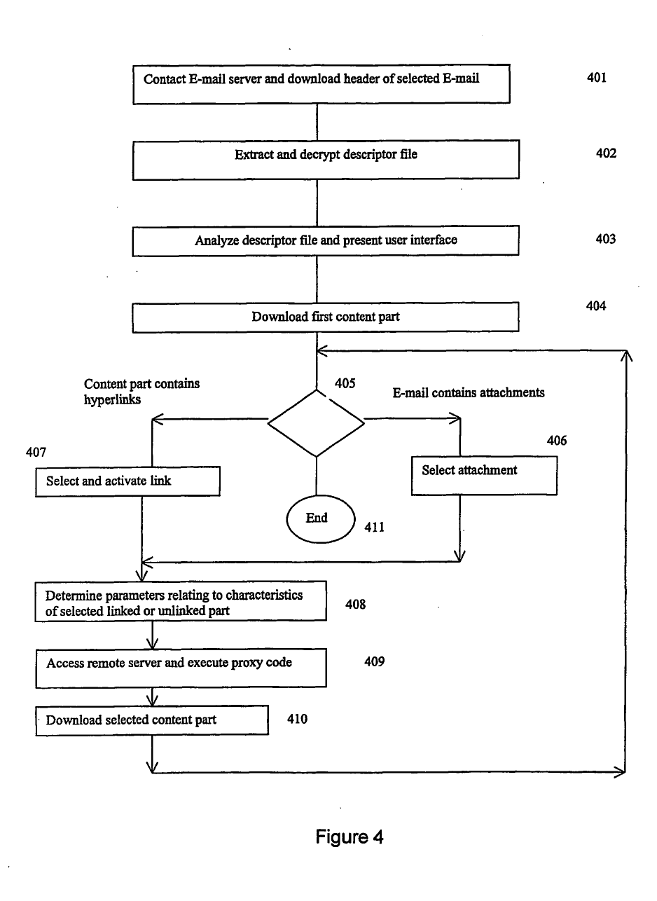

FIG. 4 illustrates exemplary steps in operating the arrangement 30. At step 401 a user contacts the e-mail server and selects e-mail. Attached to the e-mail there may be a signature or a certificate including a public key allowing the receiver to authenticate the sender. The user then requests download of the header of the selected e-mail. At step 402 the descriptor file is extracted and decrypted, e.g. using a public key algorithm. At step 403 the system makes an analysis of the descriptor file and creates a user interface. Basic data pertaining to the content parts may be shown or obtained by pointing to representative symbols e.g. illustrating a region of interest of a JPEG-image. At step 404 a user selects a first content part for download. The first content part, exemplary, comprises an overview text message including hypertext links to various attachments. At step 405 the flow chart distinguishes the case of a hypertext message having links and the case of an ordinary unlinked message having ordinary attachments. At step 411 the process ends on manual interruption by the user.

At step 407 a user activates a selected link in a hypertext content part associated with a linked content part. Similarly, in the case of an unlinked content part, a user selects in step 406 an attachment. At step 408 the system presents the user with a selection of parameters pertaining to the selected body part and characterizing a version of said part. These parameters may, exemplary, relate to image resolution, image color, and flag to include only Regions of Interest, coding of image or audio. At step 409 it is determined if the selected body part is included in the e-mail or if it must be downloaded from a remote server. In the latter case an access code may be executed to establish communication with the remote server. At step 410 download is requested of the selected information if all conditions for the access have been fulfilled.

Although an exemplary embodiment of the present invention has been described above in detail, this does not limit the scope of the invention, which can be practiced in a variety of embodiments.

1. A method for creating a multi-content e-mail having a header part and a body part comprising the steps of:
forming the body part including at least one separately encrypted information unit; and
forming the header part including an encrypted header part further comprising encrypted descriptive information and encrypted access information associated with each information unit of the body part, and wherein the header part is downloadable separately from the body part.

2. The method of claim 1 wherein that said access information at least partly comprises program executable code.

3. The method of claim 2 wherein that said executable code is arranged to be executed at a client terminal receiving the multi content e-mail and to cause the client terminal to connect to a remote server through a secure connection when executed.

4. The method according to claim 1 wherein that said descriptive information at least partly is extracted from an input file.

5. The method according to claim 4 wherein that at least the input file is retrieved from a remote server.

6. The method of claim 1 wherein that said access information associated with each information unit of the body part is retrieved from at least a remote server.

7. An arrangement for creating a multi-content e-mail having a header part and a body part comprising:
means for forming the body part including at least one separately encrypted information unit; and
means for forming the header part including an encrypted header part further comprising encrypted descriptive information and encrypted access information associated with each information unit of the body part, and wherein the header part is downloadable separately from the body part.

8. The arrangement of claim 7 wherein that said access information at least partly comprises program executable code.

9. The arrangement of claim 8 wherein that said executable code is arranged to be executed at a client terminal receiving the multi-content e-mail and to cause the client terminal to connect to a remote server through a secure connection when executed.

10. The arrangement according to claim 7 wherein that the arrangement further comprises means for extracting at least part of said descriptive information from an input file.

11. The arrangement according to claim 10 wherein that the arrangement comprises means for retrieving at least the input file from a remote server.

12. The arrangement of claim 7 wherein that said access information associated with each information unit of the body part is retrieved from at least a remote server.

13. An apparatus for accessing multi-content e-mail over a telecommunications link, including display means and input means comprising:
means for downloading and decrypting a header part of an e-mail separately from a body part of the e-mail;
means for extracting descriptive information and access information from the header part, which descriptive information and access information is associated with at least one information unit of the body part;
means for generating a displayed user interface based on said descriptive information for selection of an information unit from the least one information unit of the body part; and
means for processing the access information associated with a selected information unit and for accessing the selected information unit in accordance with the processed access information.

14. The apparatus of claim 13, wherein that said access information at least partly comprises program executable code.

15. The apparatus of claim 14, wherein that said means for processing the access information includes means for executing said program executable code to thereby cause the apparatus to connect to a remote server through a secure connection.

16. A method for accessing multi-content e-mail by means of an apparatus over a telecommunications link, which apparatus comprises display means, processing means and input means, comprising the steps of:
downloading and decrypting a header part of an e-mail separately from a body part of the e-mail;
extracting descriptive information and access information from the header part, which descriptive information and access information is associated with at least one information unit of the body part;
generating and displaying a user interface based on said descriptive information for selection of an information unit from the least one information unit of the body part;
processing the access information associated with a selected information unit, and
accessing the selected information unit in accordance with the processed access information.

17. The method of claim 16, wherein that said access information at least partly comprises program executable code.

18. The method of claim 17, wherein that said program executable code executes at said apparatus causing the apparatus to connect to a remote server through a secure connection.

19. (Cancelled)
